(19) United States
(12) Patent Application Publication
(10) Pub. No.: US 2009/0271209 A1
(43) Pub. Date: Oct. 29, 2009

(54) System and Method for Tailoring Privacy in Online Social Networks

(75) Inventors: Balachander Krishnamurthy, New York, NY (US); Craig Ellis Wills, Acton, MA (US)

Correspondence Address: AT & T Legal Department - WS;Attn: Patent Docketing, Room 2A-207, One AT & T Way, Bedminster, NJ, 07921, US

(73) Assignee: AT&T Intellectual Property I, L.P., Reno, NV (US)

(21) Appl. No.: 12/394,284

(22) Filed: Feb. 27, 2009

Related U.S. Application Data
(60) Provisional application No. 61/067,927, filed on Mar. 3, 2008.

(51) Int. Cl. G06Q 99/00; G06F 21/24

(52) U.S. Cl. 705/1; 726/30

(57) ABSTRACT

In accordance with an exemplary embodiment of the present invention, a method is provided that includes maintaining a plurality of identification bits associated with a user and a minimum personal privacy level identifying if any of the plurality of identification bits are authorized for disclosure, and receiving a request for one or more identification bits of the plurality of identification bits. The method also includes determining whether the identification bits of the request exceed the minimum personal privacy level, and if the identification bits of the request exceed the minimum personal privacy level, identifying to the user the identification bits of the request that exceed the minimum personal privacy level. A computer-readable recording medium having stored thereon computer-executable instructions is provided, and an exemplary system is provided.

This application claims the benefit of U.S. Provisional Application No. 61/067,927 filed Mar. 3, 2008, which is incorporated herein by reference.

### FIELD OF THE INVENTION

The present invention relates to privacy on computer networks, and in particular relates to a tailored privacy regime in online social networks.

### BACKGROUND OF THE INVENTION

Online social networks (OSN) have recently gained in popularity as a method of socializing electronically. OSNs raise concerns about privacy leakage. Users, often willingly, share personal identifying information about themselves, but do not have a clear idea of who accesses their private information or what portion of it really needs to be accessed.

With the increase in the number of users worldwide on OSNs, there are new and significantly higher privacy leakage concerns as compared to traditional Web sites. OSN users are encouraged to share a variety of personal identity-related information, including physical, cultural, and social attributes. Users who do this often believe that such information is accessible to the OSN and maybe their “friends” on that OSN. In reality, the set of entities that can access various bits of private information is large and diverse: third-party advertisers and data aggregators, members in the OSN who are not friends of the user, and external applications. Also, if external actions taken by users while logged in to an OSN are tracked, such information can be used not just for marketing purposes, but shared with friends of the user, possibly leading to personal embarrassment.

Many users of OSNs are unaware of who has access to their private information. In OSNs, more so than in the case of ordinary Web access, the amount and nature of private information is generally more detailed. Most users may be able to carry out a large fraction of their interactions on OSNs while significantly shrinking the amount of private information that is made available to anyone else. Many of the popular applications on OSNs do not need complete access to the private information of users, yet OSNs often give users a boolean choice to share or not share their private information if they want to download and use an externally created application. However, disclosing all of the private information maintained by an OSN in order to run some game applications on OSNs is certainly more than is necessary. Some popular gaming applications may only require friendship information to run properly.

In summary, the groupings of privacy data in current OSNs are coarse, and therefore there is no opportunity to make incremental changes in the disclosure of private information. OSNs do not provide a range of privacy settings that allow fine distinctions between private information based on a user's personal preferences. Additionally, OSNs typically have permissive default settings that allow viewing privileges, or disclose significant private information, to friends, other users, or external applications.

### BRIEF SUMMARY OF THE INVENTION

In accordance with an embodiment of the present invention, a method is provided that includes maintaining a plurality of identification bits associated with a user and a minimum personal privacy level identifying if any of the plurality of identification bits are authorized for disclosure, and receiving a request for one or more identification bits of the plurality of identification bits. The method also includes determining whether the identification bits of the request exceed the minimum personal privacy level, and if the identification bits of the request exceed the minimum personal privacy level, identifying to the user the identification bits of the request that exceed the minimum personal privacy level.

The exemplary method may also provide that the request is from an entity including one of a third party server, a third party application, and an online social network controlling interactions between the user and a member of the online social network. The exemplary method may further include, when the identification bits of the request exceed the minimum personal privacy level, identifying to the user a reduced functionality for the user of the entity if the identification bits of the request that exceed the minimum personal privacy level are not transmitted.

The exemplary method may also include requesting from the user authorization to disclose either 1) each of the identification bits of the request that exceeds the minimum personal privacy level, or 2) each of at least one predetermined grouping of the identification bits, where each of the predetermined groupings includes at least one identification bit that exceeds the minimum personal privacy level.

The exemplary method may further provide that the user is requested to authorize disclosure of each of the identification bits of the request that exceeds the minimum personal privacy level. The exemplary method may also include receiving from the user a response including an authorization to disclose at least some of the identification bits of the request that exceed the minimum personal privacy level. In the exemplary method, the response may not include an authorization to disclose at least some other identification bits of the request.

The exemplary method may also include receiving from the user the plurality of identification bits and the minimum personal privacy level, and may include receiving from the user at least one grouping of the identification bits, when at least some of the groupings include at least one identification bit that exceeds the minimum personal privacy level.

The exemplary method may provide that the plurality of identification bits and the minimum personal privacy level are maintained on a computer of the user, and the method may also include communicating at least one of the plurality of identification bits and the minimum personal privacy level to an online social network.

A computer-readable recording medium having stored thereon computer-executable instructions is provided. The computer-executable instructions cause a processor to perform a method when executed. The exemplary method performed by the processor may include any of the features of the exemplary method discussed in this application.

An exemplary system is provided that includes a database storing a plurality of identification bits associated with a user and a minimum personal privacy level identifying if any of the plurality of identification bits are authorized for disclosure, and means for receiving a request for one or more identification bits of the plurality of identification bits. The exemplary system further includes means for determining whether the identification bits of the request exceed the minimum personal privacy level, and means for identifying to the user, if the identification bits of the request exceed the minimum personal privacy level, the identification bits of the request that exceed the minimum personal privacy level.

In the exemplary system, the user may be requested to authorize disclosure of each of the identification bits of the request that exceeds the minimum personal privacy level. The exemplary system may further include means for receiving from the user a response including an authorization to disclose at least some of the identification bits of the request that exceed the minimum personal privacy level.

In the exemplary system, the request may be from an entity including one of a third party server, a third party application, and an online social network controlling interactions between the user and another member of the online social network. The exemplary system may provide that the means for identifying to the user is adapted to identify to the user a reduced functionality for the user of the entity if the identification bits of the request that exceed the minimum personal privacy level are not transmitted.

These and other advantages of the invention will be apparent to those of ordinary skill in the art by reference to the following detailed description and the accompanying drawings.

### BRIEF DESCRIPTION OF THE DRAWINGS

FIG. 1 is a schematic diagram of a system in accordance with an exemplary embodiment of the present invention;

FIG. 2 is a flowchart showing an exemplary method according to the present invention;

FIG. 3 shows a flowchart illustrating the steps performed in an exemplary embodiment of the present invention;

FIG. 4 shows a continuation of the flowchart of FIG. 3, and which continues the illustration of the steps performed in accordance with an exemplary embodiment of the present invention; and

FIG. 5 is a block diagram of a computer in accordance with an embodiment of the present invention.

### DETAILED DESCRIPTION

Users may be unaware of who has access to their private information when interacting with an Online Social Network (OSN). Interestingly, most users may be able to carry out a large fraction of their actions on OSNs while significantly shrinking the amount of private information that is made available to others. Most of the thousands of popular applications on OSNs do not need complete access to the private information of users, yet OSNs gives users no choice if they want to download and use an externally created application.

In accordance with an embodiment of the present invention, a method is provided for enumerating the precise private bits of information that are actually needed for a user to interact with and make full use of the myriad features of an OSN. The privacy bits required may vary with a specific feature because, for instance, some external applications may genuinely need more information than others. Limiting access to just friends or those in a network is not fine-grained enough. One option is to disclose information to users/networks based on need. Just as there should be a way to deny private information at each aggregation, it should be possible to both deny and enable access to private information at the same level of granularity.

OSNs should indicate to the user the bare minimum of private information needed for a particular set of interactions. If an external application requires access to a list of friends and nothing else, then the default may be that bare minimum. If additional features of the application require access to other bits of private information, then access to this supremum of information above the minimum may be enabled, and no more.

A mechanism to identify the metrics of bare minimum and supremum would be a useful addition to the privacy arsenal. Such metrics would allow comparison of various OSNs and let users decide how comfortable they are with the privacy information that is being shared. A user could create and order privacy groups, and have a threshold mark along this spectrum in terms of what privacy groups (and thus what bits) they are willing to share freely (i.e., the minimum). For each set of interactions or use of an application, the OSN could indicate what information bits are needed and if the bits are within the user's threshold (i.e., within the group of freely shared information), access is provided transparently. If some additional bits outside the user's threshold are essential, then the user can be prompted. The user can then allow or disallow, and/or optionally set the duration (e.g., for a current session, forever etc.) for such a grant.

The mechanism will order the private bits of information belonging to a user and reveal it in increasing order of the value (as determined by the user) to an application that requests it. If the application does not need any private information, none is made available. Once the needs of the application are met, no additional information is disclosed. The level in which private information is made available would vary with the application and the importance assigned to the private bits by the user.

The exemplary method and system of the present invention provides an improvement on the either/or authorization of traditional OSNs, by creating a negotiation process. The exemplary method does not merely provide that, when the third party application asks for y private bits, the OSN (on behalf of the user) provides x private bits (where x<y), then the third party application requests that the OSN ask the user for >x private bits, and then the OSN asks the user for authorization to send y private bits (where y>x). Rather the exemplary method of the present invention provides a negotiation whereby the third party application indicates why y private bits are needed, and what might happen if just x private bits are sent. The user can then decide either to send y private bits or not transmit more than x private bits. Additionally, the user may decide to transmit x+z private bits (where x+z is still <y).

As a result of this mechanism, a user may be comfortable in knowing that while private information was shared, it was shared at the bare minimum level, and never more than the supremum needed for the successful execution of the application or the interaction with the social network.

The parties involved are myriad: the OSN application itself; the set of external applications that users download and run; the set of friends and members of networks to which the user belongs; other users in the OSN; advertisers who are interested in user-related information; and third party domains and aggregators that gather private information on behalf of the OSN, applications, and advertisers etc. Likewise, the bits of private information vary: lists of user's friends and followers; explicit identity related information such as birthdate, address etc.; the list of applications a user has downloaded; the range of interactions and interactors (IM, chat, shared bulletin board); and a set of sites visited by the user or links provided by the users.

An exemplary method and system of the present invention aggregates the various bits of private information, sorts them in order of importance (allowing the user to override any default valuation associated with them), computes which of these bits are required by a downloaded application (the information can also be made explicitly available by the application), and indicates to the user what information is being shared and with whom before actually sharing the privacy bits.

The tailored privacy mechanism helps build the bare minimum and supremum for each interaction and allows the user to share the right portion of private information with the appropriate entities seeking the information.

An exemplary embodiment of the invention identifies the various parties involved, the various bits of privacy information, the various actions that involve potential sharing of a subset of these private bits of information, and the need for providing the bare minimum and supremum of privacy information for the associated action(s) to be performed effectively.

The particular OSN may first enumerate a list of the private bits of information which may possibly be shared. The user may rank these bits in order based on his/her personal privacy valuation. For example, some users might not care if an OSN told the whole world about their list of friends, but might not want another OSN's users to find out who else wrote on their shared bulletin board.

In an exemplary embodiment of the present invention, the burden may be on the OSN to allow the user to specify the amount of data disclosed. Currently the choices offered to users have a coarse granularity and do not take into account the varying privacy levels of data elements needed for different applications. One way to simplify the interactions is to define “threshold levels”. In addition to a “bare minimum” and a “supremum”, there could possibly be other levels, and users can create, customize and select a multitude of different levels.

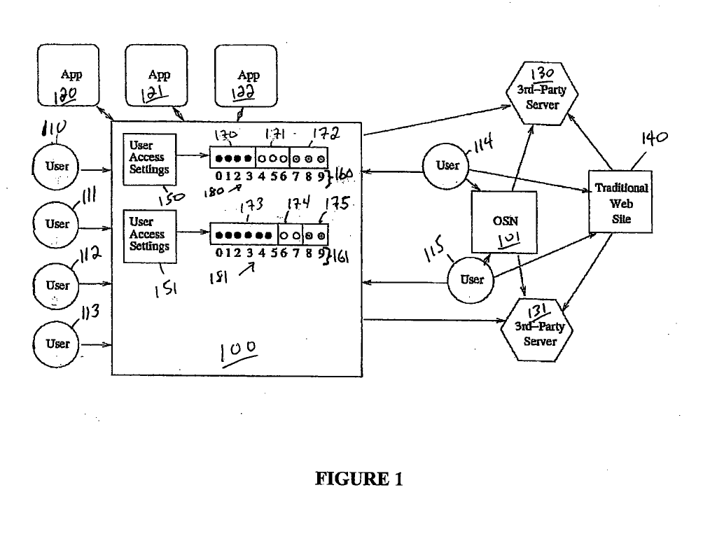

FIG. 1 shows an exemplary embodiment of the present invention, including OSN 100, and OSN 101. Users 110, 111, 112, 113, 114, and 115, all access OSN 100. Users 114 and 115 each also access OSN 101 in addition to OSN 100. Applications 120, 121, and 122 each interact with OSN 100. OSN 100 may reside on one or more servers and may be accessed by users 110-115 via a network, for instance, the Internet. Likewise, Applications 120-122 may reside on the same or different servers as OSN 100. OSN 100 includes user access settings 150 and 151. User access setting 150 corresponds to User 110's privacy levels and are created based on user 110's preferences. User 110 inputs privacy bits 180 into OSN 100 at an initial registration interaction and/or at later interactions with OSN 100. Privacy bit vector 160 is composed of privacy bits 180. Privacy bits 180, shown as “0, 1, 2, 3, 4, 5, 6, 7, 8, 9” in FIG. 1, form a set of privacy bits and may include any type and quantity of personal information, including but not limited to name, age, birthdate, contact email, friends, group membership, etc. User access setting 150 of user 110 may group privacy bits 180 into privacy bit groups 170, 171, and 172 based on the personal privacy thresholds of user 110. Privacy bit groups 170, 171, and 172 may also be referred to as privacy bit sub-vectors. User access setting 151, privacy bit vector 161, privacy bits 181, and privacy bit groups 173, 174 and 175 correspond to user 111, and other user access settings may be provided for users 112-115.

User access setting 150 of user 110 regulate the disclosure of privacy bits 180 to applications 120-122 by OSN 100. For instance, if user 100 accesses application 120 during a session using OSN 100, application 120 may request certain privacy bits 180 of the set of privacy bits 180 relating to user 110 from OSN 100. User access setting 150 of user 110 may provide that the privacy bits 180 included in privacy bit group 172 may be disclosed to application 120 without additional authorization. Therefore, if application 120 only requests privacy bits 180 included in privacy bit group 172, then OSN 100 would provide all of the requested privacy bits 180 requested by application 120 and user 110 would be able to take advantage of all of the functionality of application 120. However, if application 120 requested particular privacy bits 180 that were not included in privacy bit group 172, then an authorization from user 110 would be required for OSN 100 to disclose the requested privacy bits 180 not in privacy bit group 172. In this situation, OSN 100 may indicate to user 110 that application 120 requires additional privacy bits 180, and may also indicate which specific privacy bits 180 that are not a part of privacy bit group 172 are requested. Additionally, OSN 100 may receive information from application 120 indicating that different levels of functionality of application 120 are possible, and that failure to authorize disclosure by user 110 of the additional privacy bits 180 not included in privacy bit group 172 will result in a reduced functionality of application 120. A reduced functionality as referred to herein may be a single lost functionality or a spectrum of lost functionality correlated with a variety of privacy bits 180. User 110 may then decide to authorize a full disclosure of all privacy bits 180 requested by application 120, may decide to selectively authorize individual privacy bits within the set of privacy bits 180 (for instance, only distinct bits 1, 5, 8 may be authorized for disclosure), may authorize only disclosure of certain privacy bit groups 171 or 170, or may not authorize any additional disclosures beyond privacy bit group 172 (i.e., only the bare minimum).

An exemplary hierarchy of privacy bit groups 170-172 may be that privacy bit group 172 is a bare minimum, privacy bit group 171 is a supremum, and privacy bit group 170 is a maximum. User access setting 150 of user 110 may indicate that privacy bit group 172 may be freely shared during any action of user 110 without additional action, privacy bit group 171 may be shared upon a specific authorization from user 110, and privacy bit group 170 may not be disclosed unless a specific overriding authorization is provided by user 110.

Third party servers 130 and 131 may also interact with OSN 100 and/or OSN 101. Third party servers 130, 131 may also interact with traditional website 140, and users 114, 115 may also interact directly with traditional website 140. privacy bit groups 170-172 of user 110 may also regulate interaction with third party servers 130, 131, and traditional website 140, as well as disclosure of privacy bits 180 with other users (e.g., users 111-115) of OSN 100.

An alternative exemplary embodiment provides that groupings of privacy bits 180 into privacy bit groups 170, 171, and 172 based on user access setting 150 of user 110 may be stored on a computer of user 110, and not on a server running OSN 100. In this manner, users 114 and 115 may use their own user access settings with both OSN 100 and OSN 101. In this manner, user 110 may have increased control of their privacy bits across different OSNs with which they interact. In this manner, their user access settings would be stored locally and communicated to each OSN with an Application Program Interface (API), or an alternative arrangement. Alternately, the user may maintain separate profiles with each OSN.

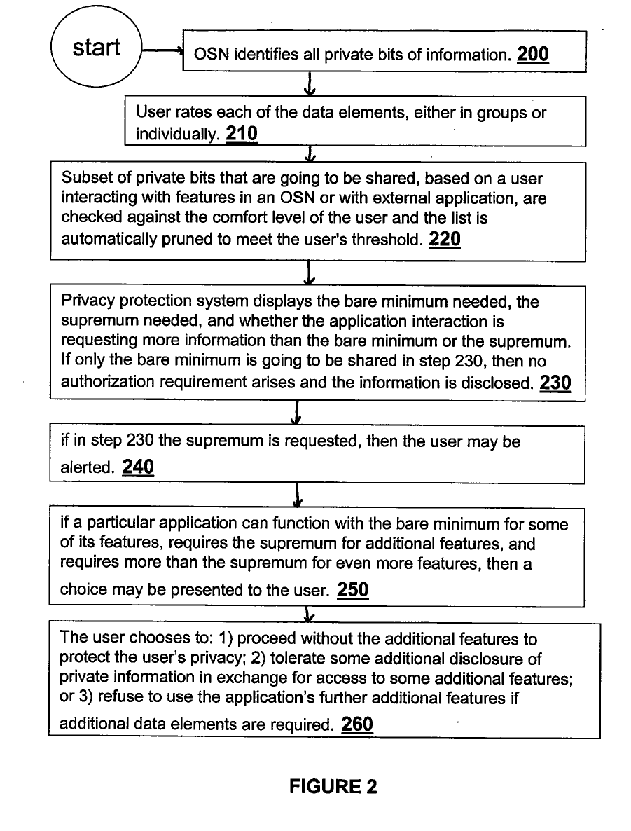

In an exemplary method the following steps may be performed, which are shown in the flowchart of FIG. 2. Step 200 may provide that an OSN identifies all private bits of information (also referred to herein as data elements). In step 210, a user may rate each of the data elements, either in groups or individually. Step 220 may indicate that, as a user starts interacting with features in an OSN or with external application, the subset of private bits that are going to be shared is checked against the comfort level of the user and the list is automatically pruned to meet the user's threshold. In step 230, the privacy protection system may display the bare minimum needed, the supremum needed, and whether the application interaction is requesting more information than the bare minimum or the supremum. If only the bare minimum is going to be shared in step 230, then no authorization requirement arises and the information is disclosed. However, if in step 230 the supremum is requested, then the user may be alerted in step 240, and if more than the supremum is requested, then the process may be terminated. In step 250, if a particular application can function with the bare minimum for some of its features, requires the supremum for additional features, and requires more than the supremum for even more features, then a choice may be presented to the user. The user can choose in step 260 to: 1) proceed without the additional features to protect the user's privacy; 2) tolerate some additional disclosure of private information in exchange for access to some additional features; or 3) refuse to use the application's further additional features if additional data elements are required. In other words, an application can have multiple levels of functionality corresponding to the amount of data required.

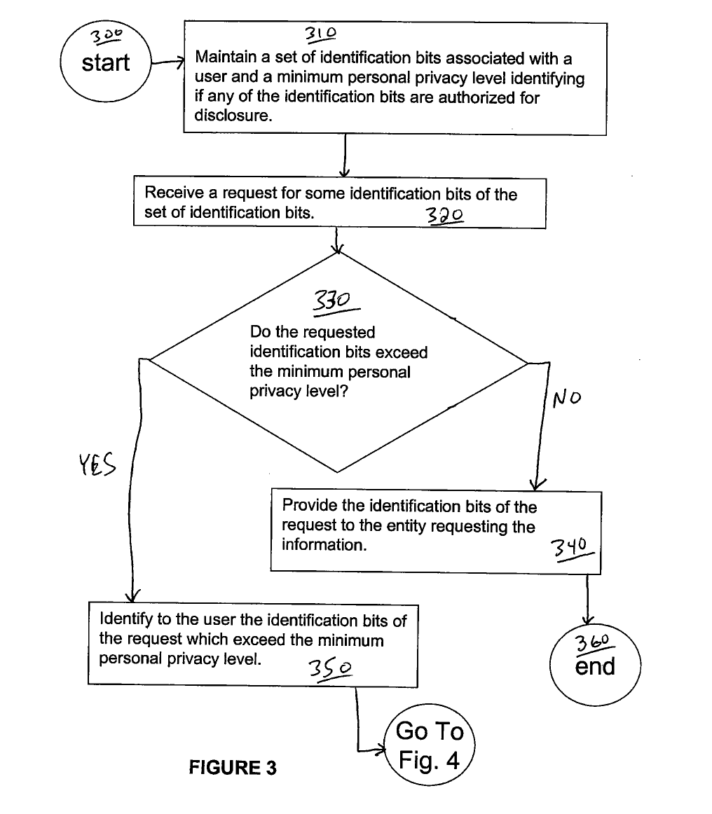

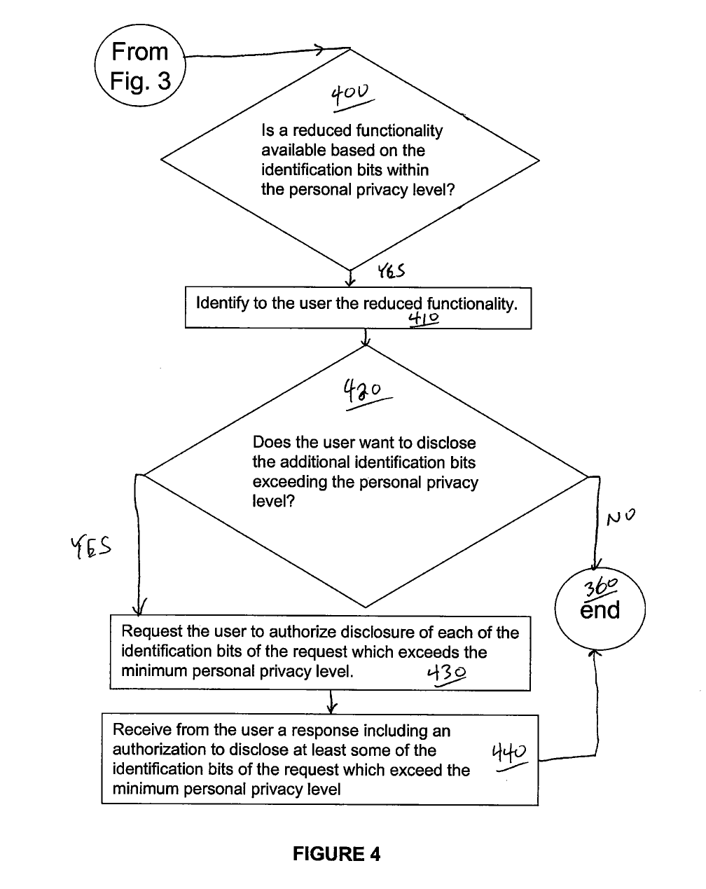

FIG. 3 and FIG. 4 illustrate an exemplary method according to the present invention with a flow chart. The method starts at circle 300 of FIG. 3 and proceeds to operation 310, which operates to maintain a set of identification bits associated with a user and a minimum personal privacy level identifying if any of the identification bits are authorized for disclosure. The maintenance performed in operation 310 may be performed by an OSN or by a user. Operation 310 proceeds to operation 320, which functions to receive a request for some identification bits of the set of identification bits. The request for identification bits may be received from a third party server, a third party application, or from the OSN itself for an interaction with another user of the OSN. This request for information may take any number of forms, and may require a mapping by the OSN of the requested information to the identification bits of the user. In some embodiments, this mapping may be maintained privately within the OSN to prevent disclosure of the types of identification information stored by the OSN. Operation 320 proceeds to decision 330, which asks if the requested identification bits exceed the minimum personal privacy level. If the response to decision 330 is negative the flow proceeds to operation 340, which indicates to provide the identification bits of the request to the entity requesting the information. From operation 340 the flow proceeds to end circle 360. If the response to decision 330 is affirmative, the flow proceeds to operation 350 which indicates to identify to the user the identification bits of the request that exceed the minimum personal privacy level. From operation 350 the flow proceeds to FIG. 4.

FIG. 4 begins at decision 400 which determines whether a reduced functionality is available based on the identification bits within the personal privacy level. As discussed previously, a reduced functionality in this case may represent a spectrum of reduced functionalities. If the response to decision 400 is affirmative, the flow proceeds to operation 410 which indicates to identify to the user the reduced functionality. From operation 410 the flow proceeds to decision 420, which asks if the user wants to disclose the additional identification bits exceeding the personal privacy level. If the response to the query in decision 400 is negative, the flow proceeds directly to decision 420. From decision 420, if the response is affirmative, the flow proceeds to operation 430, which indicates to request the user to authorize disclosure of each of the identification bits of the request that exceeds the minimum personal privacy level. From operation 430 the flow proceeds to operation 440, which indicates to receive from the user a response including an authorization to disclose at least some of the identification bits of the request that exceed the minimum personal privacy level. From operation 440, the flow proceeds to end circle 360. If the response to decision 420 is negative, the flow proceeds directly to end circle 360.

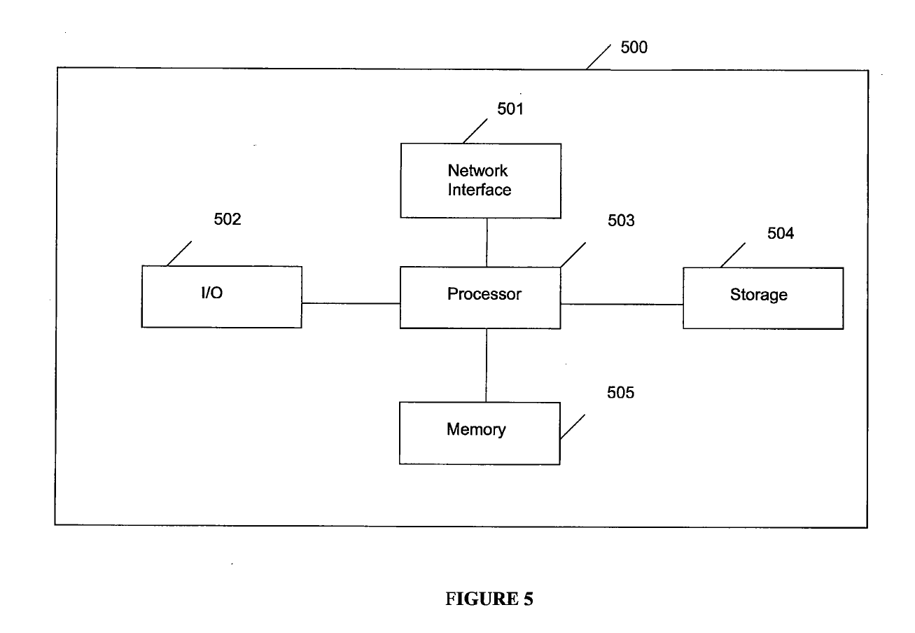

FIG. 5 is a high level block diagram of a computer in accordance with an embodiment of the present invention. The computer 500 can, for example, operate as any of the entities in FIG. 1, including users 110-115, OSNs 100, 101, applications 120-122, third party servers 130, 131, or as traditional Website 140. Additionally, computer 500 can perform the steps described above (e.g., with respect to FIGS. 3 and 4). Computer 500 contains processor 503 which controls the operation of the computer by executing computer program instructions which define such operation, and which may be stored on a computer-readable recording medium. The computer program instructions may be stored in storage 504 (e.g., a magnetic disk, a database) and loaded into memory 505 when execution of the computer program instructions is desired. Thus, the computer operation will be defined by computer program instructions stored in memory 505 and/or storage 504 and computer 500 will be controlled by processor 503 executing the computer program instructions. Computer 500 also includes one or more network interfaces 501 for communicating with other devices, for example other computers, servers, or websites. Network interface 501 may, for example, be a local network, a wireless network, an intranet, or the Internet. Computer 500 also includes input/output 502, which represents devices which allow for user interaction with the computer 500 (e.g., display, keyboard, mouse, speakers, buttons, webcams, etc.). One skilled in the art will recognize that an implementation of an actual computer will contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

1. A method, comprising:
maintaining a plurality of identification bits associated with a user and a minimum personal privacy level identifying if any of the plurality of identification bits are authorized for disclosure;
receiving a request for one or more identification bits of the plurality of identification bits;
determining whether the identification bits of the request exceed the minimum personal privacy level; and
if the identification bits of the request exceed the minimum personal privacy level, identifying to the user the identification bits of the request that exceed the minimum personal privacy level.

2. The method according to claim 1, wherein the identification bits of the request exceed the minimum personal privacy level, and wherein the request is from an entity including one of a third party server, a third party application, and an online social network controlling interactions between the user and a member of the online social network, and further comprising:
identifying to the user a reduced functionality for the user of the entity if the identification bits of the request that exceed the minimum personal privacy level are not transmitted.

3. The method according to claim 1, further comprising requesting from the user authorization to disclose one of:
each of the identification bits of the request that exceeds the minimum personal privacy level, and
each of at least one predetermined grouping of the identification bits, each of the predetermined groupings including at least one identification bit that exceeds the minimum personal privacy level.

4. The method according to claim 3, wherein the user is requested to authorize disclosure of each of the identification bits of the request that exceeds the minimum personal privacy level, and further comprising:
receiving from the user a response including an authorization to disclose at least some of the identification bits of the request that exceed the minimum personal privacy level.

5. The method according to claim 4, wherein the response does not include an authorization to disclose at least some other identification bits of the request, and wherein the request is from an entity including one of a third party server, a third party application, and an online social network controlling interactions between the user and a member of the online social network, and further comprising:
identifying to the user a reduced functionality for the user of the entity if at least some of the at least some other identification bits of the request are not disclosed.

6. The method according to claim 5, further comprising receiving from the user authorization to disclose the at least some of the at least some other identification bits of the request.

7. The method according to claim 1, wherein the method is performed by an online social network.

8. The method according to claim 1, further comprising receiving from the user the plurality of identification bits and the minimum personal privacy level.

9. The method according to claim 1, further comprising receiving from the user at least one grouping of the identification bits, at least some of the groupings including at least one identification bit that exceeds the minimum personal privacy level.

10. The method according to claim 1, wherein the plurality of identification bits and the minimum personal privacy level are maintained on a computer of the user; and
further comprising communicating at least one of the plurality of identification bits and the minimum personal privacy level to an online social network.

11. A computer-readable recording medium having stored thereon computer-executable instructions, the computer-executable instructions causing a processor to perform a method when executed, the method comprising:
maintaining a plurality of identification bits associated with a user and a minimum personal privacy level identifying if any of the plurality of identification bits are authorized for disclosure;
receiving a request for one or more identification bits of the plurality of identification bits;
determining whether the identification bits of the request exceed the minimum personal privacy level; and
if the identification bits of the request exceed the minimum personal privacy level, identifying to the user the identification bits of the request that exceed the minimum personal privacy level.

12. The computer-readable recording medium according to claim 11, wherein the identification bits of the request exceed the minimum personal privacy level, and wherein the request is from an entity including one of a third party server, a third party application, and an online social network controlling interactions between the user and a member of the online social network, and the method further comprising:
identifying to the user a reduced functionality for the user of the entity if the identification bits of the request that exceed the minimum personal privacy level are not transmitted.

13. The computer-readable recording medium according to claim 11, the method further comprising requesting from the user authorization to disclose one of:
each of the identification bits of the request that exceeds the minimum personal privacy level, and
each of at least one predetermined grouping of the identification bits, each of the predetermined groupings including at least one identification bit that exceeds the minimum personal privacy level.

14. The computer-readable recording medium according to claim 13, wherein the user is requested to authorize disclosure of each of the identification bits of the request that exceeds the minimum personal privacy level, and the method further comprising:
receiving from the user a response including an authorization to disclose at least some of the identification bits of the request that exceed the minimum personal privacy level.

15. The computer-readable recording medium according to claim 14, wherein the response does not include an authorization to disclose at least some other identification bits of the request, and wherein the request is from an entity including one of a third party server, a third party application, and an online social network controlling interactions between the user and a member of the online social network, and the method further comprising:
identifying to the user a reduced functionality for the user of the entity if at least some of the at least some other identification bits of the request are not disclosed.

16. The computer-readable recording medium according to claim 15, the method further comprising receiving from the user authorization to disclose the at least some of the at least some other identification bits of the request.

17. The computer-readable recording medium according to claim 11, the method further comprising receiving from the user the plurality of identification bits and the minimum personal privacy level.

18. The computer-readable recording medium according to claim 11, the method further comprising receiving from the user at least one grouping of the identification bits, at least some of the groupings including at least one identification bit that exceeds the minimum personal privacy level.

19. The computer-readable recording medium according to claim 11, wherein the plurality of identification bits and the minimum personal privacy level are maintained on a computer of the user; and
the method further comprising communicating at least one of the plurality of identification bits and the minimum personal privacy level to an online social network.

20. A system comprising:
a database storing a plurality of identification bits associated with a user and a minimum personal privacy level identifying if any of the plurality of identification bits are authorized for disclosure;
means for receiving a request for one or more identification bits of the plurality of identification bits;
means for determining whether the identification bits of the request exceed the minimum personal privacy level; and
means for identifying to the user, if the identification bits of the request exceed the minimum personal privacy level, the identification bits of the request that exceed the minimum personal privacy level.

21. The system according to claim 20, wherein the user is requested to authorize disclosure of each of the identification bits of the request that exceeds the minimum personal privacy level, and further comprising:
means for receiving from the user a response including an authorization to disclose at least some of the identification bits of the request that exceed the minimum personal privacy level.

22. The system according to claim 20, wherein:
the request is from an entity including one of a third party server, a third party application, and an online social network controlling interactions between the user and a member of the online social network, and
the means for identifying to the user is adapted to identify to the user a reduced functionality for the user of the entity if the identification bits of the request that exceed the minimum personal privacy level are not transmitted.

23. The system according to claim 20, wherein the database is maintained on a computer of the user; and
means for communicating at least one of the plurality of identification bits and the minimum personal privacy level to an online social network.
